(19) United States
(12) Patent Application Publication
(10) Pub. No.: US 2005/0163000 A1
(43) Pub. Date: Jul. 28, 2005

(54) Optical information recording/reproducing device for performing at servo control by DPP method

(75) Inventor: Koichiro Nishikawa, Takasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/023,378

(22) Filed: Dec. 29, 2004

(30) Foreign Application Priority Data
Jan. 27, 2004 (JP) 018456/2004

(51) Int. Cl. G11B 7/00

(52) U.S. Cl. 369/44.37; 369/44.29; 369/44.41

(57) ABSTRACT

An optical information recording/reproducing device makes use of a differential push-pull (DPP) method. In the optical information recording/reproducing device, after amplification of a push-pull signal of first and second subbeams at a first predetermined ratio, a differential between the push-pull signal of the first and second subbeams and a push-pull signal of a main beam is determined in order to generate a tracking control signal. In addition, after amplification of the push-pull signal of the first and second subbeams at a predetermined second ratio, a summation of the push-pull signal of the first and second subbeams and the push-pull signal of the main beam is determined in order to generate an objective lens position signal. The first predetermined ratio and the second predetermined ratio are different.

### BACKGROUND OF THE INVENTION

1. Field of the Invention

The present invention relates to an optical information recording/reproducing device for recording information onto or reproducing the recorded information from an information recording medium. More particularly, the present invention relates to a device for generating a tracking error signal and an objective lens position detection signal by a differential push-pull method (hereunder referred to as the “DPP method”).

2. Description of the Related Art

The DPP method is conventionally known as a tracking servo method of a drive for an optical recording disc, such as a CD-R or a DVD-R. The DPP method is carried out to generate a tracking error signal by performing a calculation on output signals from photodetecting units. The output signals are obtained from a main beam and two subbeams.

The tracking error signal generated by the DPP method is a signal for controlling offset resulting from the movement of an objective lens. It is known that an objective lens position detection signal is generated by changing the calculation method. Such a technology is disclosed in, for example, Japanese Patent Laid-Open Nos. 7-93764 and 2000-331356.

In that technology, first, light emitted from a light source is divided into a main beam and two subbeams. Then, the main beam and the two subbeams are converged on an optical disc by an objective lens, are reflected by the optical disc, and are received by photodetecting units 12, 13, and 14 as shown in FIG. 3. The photodetecting unit 12 that receives the main beam is vertically and horizontally divided into four elements. The photodetecting units 13 and 14 that receive the subbeams are each vertically divided into two elements. A, B, C, D, E, F, G, and H denote outputs from the divided elements. Performing calculations on signals of the outputs A to H produces a tracking error signal and a lens position detection signal.

More specifically, the signals are generated as follows with an operational circuit shown in FIG. 4. In FIG. 4, reference numerals 20, 21, 22, and 25 denote differential amplifiers, reference numerals 23, 26, 27, and 28 denote summing amplifiers, and reference numeral 24 denotes an amplifier. Reference characters A to H in FIG. 4 correspond to the outputs A to H of the respective elements in FIG. 3. A main beam push-pull signal MPP is generated as an output of the differential amplifier 20 by the following formula:
MPP=(A+D)−(B+C)

A subbeam push-pull signal SPP is generated as an output of the summing amplifier 23 by adding outputs of the differential amplifiers 21 and 22 in accordance with the following formula:
SPP=(E−F)+(G−H)
A DPP signal is generated as an output of the differential amplifier 25 by determining the differential between the MPP signal and a signal obtained by multiplying K0 and the SPP signal by the amplifier 24 in accordance with the following formula:
DPP=MPP−K0×SPP

Here, K0 is a constant for correcting the difference between the intensities of the main beam and the two subbeams. K0 is set, for example, so that a DC offset caused by the movement of the objective lens does not occur.

A lens position detection signal LPS is generated as an output of the summing amplifier 26 by the following formula:
LPS=MPP+K0×SPP

In FIG. 4, the DPP and LPS signals are generated by amplifying the SPP signal at the amplifier 24 and then branching it. However, the DPP and LPS signals may also be generated by branching the SPP signal and then amplifying the branched portions at the amplifier 24.

By, for example, rotational adjustment around an optical axis of a diffraction grating, spots are disposed on the optical disc such that a main beam spot 17 is disposed on a groove 15 and subbeam spots 18 and 19 are symmetrically disposed on lands 16 on both sides of the main beam spot 17 as shown in FIG. 5. In other words, when a groove period is used as a reference, the interval between the main beam spot and each subbeam spot is substantially half the groove period.

Setting K0 to a proper value makes it possible for the DPP signal to have an amplitude that is substantially equal to the expected maximum value, and to restrict the occurrence of offset caused by the movement of the objective lens. At the same time, an offset component of the LPS signal, produced by each push-pull signal as a result of the movement of the objective lens, is extracted. Therefore, a signal that is in correspondence with the movement of the objective lens is generated. The LPS signal is used to restrict vibration of the objective lens when an optical head performs a seeking operation on the optical disc in a radial direction of the optical disc, or to prevent the objective lens from being displaced by its own weight due to the posture of the optical head.

However, an optical head of a device using the DPP method has the following problems.

(1) In adjusting the assembly of the optical head, an error occurs in the rotational adjustment of the diffraction grating. As a result, as shown in FIG. 6, the subbeams are displaced from the land centers that are situated at a distance corresponding to ½ of the groove interval.

(2) An error in adjusting the assembly of the optical head, the difference between the wavelength of the light source and a design wavelength, an error in the position of the diffraction grating, and an error in producing an element, etc., cause the subbeams 32 and 33 to be displaced from the division lines of the photodetecting units as shown in FIG. 7.

(3) When an error in adjusting the assembly of the optical head occurs, the main beam, which actually needs to impinge upon the objective lens vertically, obliquely impinges upon the objective lens, and the subbeams, which actually need to obliquely impinge upon the objective lens at opposite sides at angles having the same absolute value, impinge upon the objective lens so that the oblique incident angle of one of the subbeams is greater than that of the other subbeam.

When problem (1) occurs, the subbeam push-pull signals no longer have the same phase in terms of the groove period. As a result, the output of the summing amplifier 23 can no longer have an amplitude that is equal to the expected maximum amplitude, causing the quality of the SPP signal to be reduced compared to the quality of the MPP signal. In other words, the quality of the SPP signal deteriorates.

When problem (2) occurs, the relationship between the phases of the push-pull signals is not adversely affected. However, the subbeams are displaced with respect to the division lines of the photodetecting units, and the amplitude of the subbeam push-pull signals is reduced as shown in FIG. 8. As a result, the quality of the SPP signal is reduced.

When problem (3) occurs, the quality of the spot of the subbeam whose oblique incident angle is increased is reduced. Therefore, the push-pull signal reproduction performance is reduced, thereby deteriorating the quality of the SPP signal.

Therefore, the ratio of an SPP signal offset, resulting from the movement of the objective lens, with respect to the amplitude of the SPP signal becomes greater than the ratio of an MPP signal offset, resulting from the movement of the objective lens, with respect to the amplitude of the MPP signal. When K0 is set so as to restrict the occurrence of DC offset resulting from the movement of the objective lens in the formula DPP=MPP−K0×SPP, a push-pull modulation component can no longer be cancelled in the formula LSP=MPP+K0×SPP. Therefore, the quality of the lens position detection signal is considerably reduced, and the push-pull modulation component remains in the lens position detection signal. As a result, the vibration of the objective lens occurring when the optical head carries out a seeking operation on the optical disc in a radial direction of the optical disc is less effectively restricted, and the displacement of the objective lens caused by its own weight due to the posture of the optical head is less effectively prevented. Consequently, the performance of an optical disc device is considerably reduced.

When the push-pull modulation component is cancelled in the formula LSP=MPP+K0×SPP, DC offset occurs due to the movement of the objective lens in the formula DPP=MPP−K0×SPP. This reduces the tracking servo control performance and the allowable decentering value of the optical disc. Therefore, the performance of the optical disc device is considerably reduced.

### SUMMARY OF THE INVENTION

It is an object of the present invention to provide an optical information recording/reproducing device which can continue providing good performance even if an unavoidable error occurs in an optical head of a device using the DPP method.

To this end, according to the present invention, there is provided an optical information recording/reproducing device comprising an optical element for dividing light emitted from a light source into a main beam and first and second subbeams by a wavefront splitter disposed between the light source and an objective lens. A photodetector is provided for receiving the main beam and the first and second subbeams after the main beam and the first and second subbeams are converged on an optical recording medium by the objective lens and are reflected by the optical recording medium. Also, a circuit is provided for generating a tracking control signal and an objective lens position detection signal on the basis of light signals received from the photodetector. The circuit amplifies a push-pull signal of the first and second subbeams at a first predetermined ratio and then determines a differential between the push-pull signal of the first and second subbeams and a push-pull signal of the main beam in order to generate the tracking control signal, and amplifies the push-pull signal of the first and second subbeams at a predetermined second ratio. The circuit then adds the push-pull signal of the first and second subbeams and the push-pull signal of the main beam in order to generate the objective lens position detection signal, the first predetermined ratio and the second predetermined ratio being different.

Further objects, features and advantages of the present invention will become apparent from the following description of the preferred embodiment with reference to the attached drawings.

### BRIEF DESCRIPTION OF THE DRAWINGS

FIG. 1 shows the structure of an optical head of an optical information recording/reproducing device using the DPP method in accordance with the present invention.

FIG. 2 shows a circuit for generating a DPP signal and a lens position detection signal in accordance with the present invention.

FIG. 3 shows the structure of a photodetector shown in FIG. 1.

FIG. 4 shows a circuit for generating a DPP signal and a lens position detection signal in a related art.

FIG. 5 shows a disposition of spots on an optical disc.

FIG. 6 shows a disposition of spots on the optical disc in order to explain a related problem.

FIG. 7 shows a disposition of beams on a photodetector in order to explain a related problem.

FIG. 8 is a graph showing the relationship between the displacement of subbeams and the amplitude of subbeam push-pull signals.

### DESCRIPTION OF THE PREFERRED EMBODIMENT

The best mode for carrying out the invention will be described in detail with reference to the relevant drawings. FIG. 1 shows the structure of an embodiment of the present invention. A diffraction grating 2 is disposed in a path in which a light beam emitted from a laser diode 1 travels back and forth. When the light beam emitted from the laser diode 1 lands on an optical disc 8 as a result of passing through a polarization beam splitter 3, a collimator lens 5, a ¼ wavelength plate 6, and an objective lens 7, three light beam spots, that is, spots formed by a zeroth-order diffraction light beam (main beam) and two diffraction light beams (subbeams), are formed on the optical disc 8.

The main beam and the subbeams reflected by the optical disc 8 pass again through the objective lens 7, the ¼ wavelength plate 6, and the collimator lens 5, and impinge upon the polarization beam splitter 3. The incident light beams are reflected by the polarization beam splitter 3, pass through a cylindrical lens 10, and are received by a photodetector 11. The cylindrical lens 10 detects a focusing error by astigmatism correction. Reference numeral 9 denotes a sensor lens, and reference numeral 4 denotes an APC sensor for carrying out APC control of the laser diode 1.

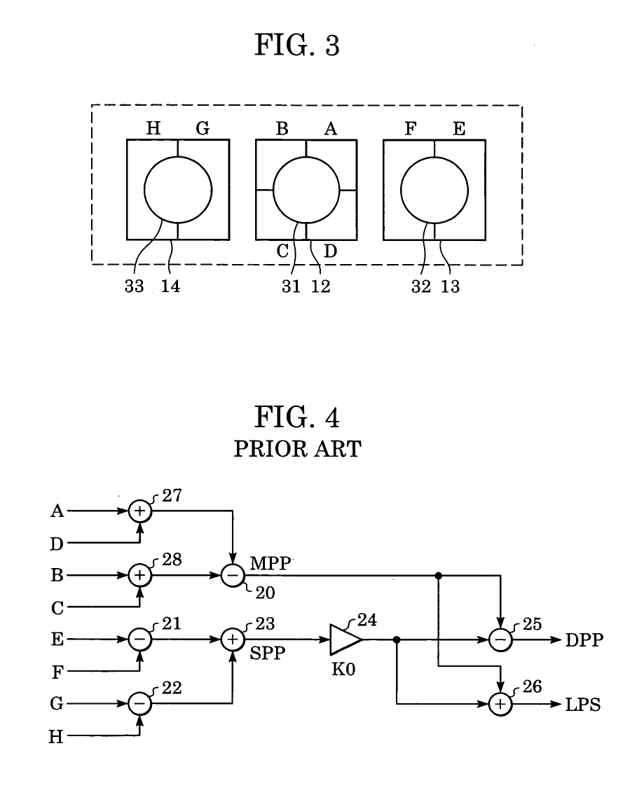

As shown in FIG. 3, the photodetector 11 comprises a main beam photodetecting unit 12 and a subbeam photodetecting units 13 and 14. The main beam photodetecting unit 12 is vertically (that is, in a track direction of the optical disc) and horizontally divided into four elements. The subbeam photodetecting units 13 and 14 are each vertically divided into the two elements. Performing calculations on signals of outputs A, B, C, D, E, F, G, and H of the divided elements produces a tracking error signal and a lens position detection signal.

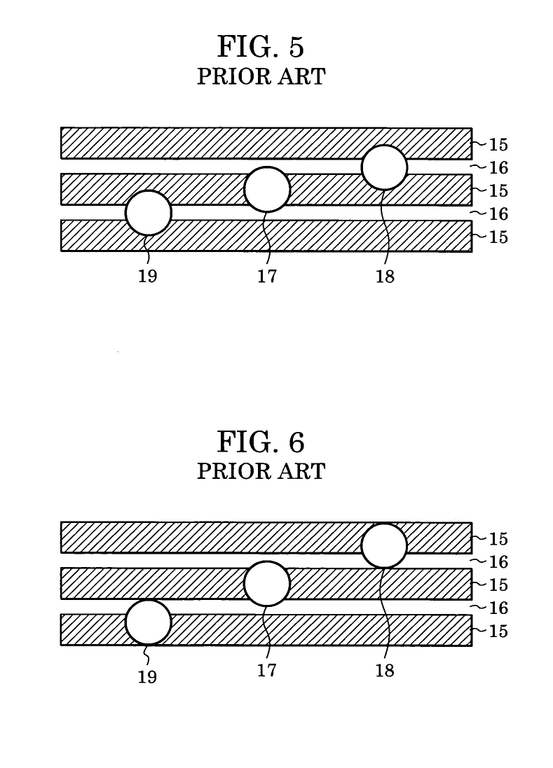

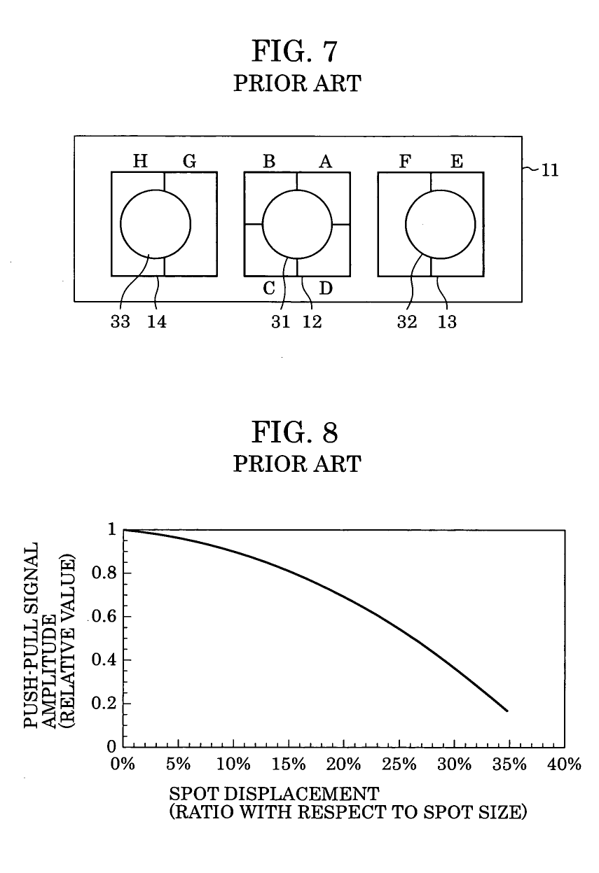

By rotational adjustment around an optical axis of the diffraction grating 2, spots are disposed on the optical disc 8 such that, for example, a main beam spot 17 is disposed on a groove (track) 15 and subbeam spots 18 and 19 are symmetrically disposed on lands 16 on both sides of the main beam spot 17 as shown in FIG. 5. In other words, when a groove period is used as a reference, the interval between the main beam spot 17 and each of the subbeam spots 18 and 19 is substantially half the groove period. As a result, subbeam push-pull signals have the same phase in terms of the groove period, and a main beam push-pull signal has a phase that is the reverse of the subbeam push-pull signals.

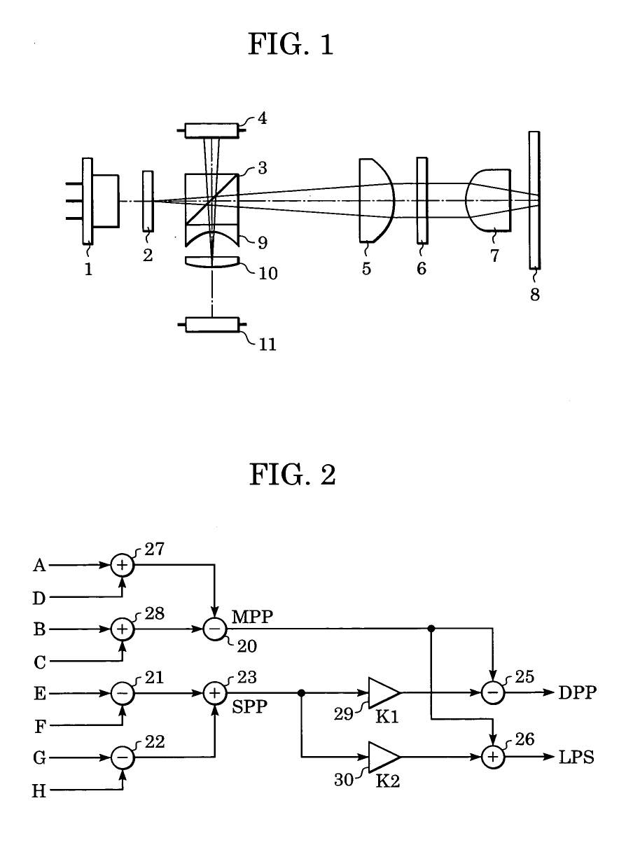

In a method for generating a tracking error signal and a lens position detection signal, the signals are generated by an operational circuit shown in FIG. 2 as follows. In FIG. 2, parts corresponding to those shown in FIG. 4 are given the same reference numerals. Reference characters A to H in FIG. 2 correspond to the outputs A to H of the respective elements of the photodetector 11 shown in FIG. 3.

Summation signals A and D from a summation amplifier 27 and summation signals B and C from a summation amplifier 28 are input to a differential amplifier 20 in order to generate a main beam push-pull signal MPP as an output from the differential amplifier 20 by the following formula:
MPP=(A+D)−(B+C)

Subbeam push-pull signals are generated as outputs from differential amplifiers 21 and 22, and then are added in order to generate a subbeam push-pull signal SPP as an output from a summation amplifier 23 by the following formula:
SPP=(E−F)+(G−H)

A DPP signal is generated as an output of a differential amplifier 25 (used for providing a differential between the MPP signal and a signal obtained by multiplying the SPP signal to K1 by an amplifier 29) by the following formula:
DPP=MPP−K1×SPP

Here, K1 is set so that an offset does not occur in the DPP signal when the objective lens 7 is moved by a predetermined amount in a radial direction of the optical disc. The predetermined amount is set greater than an allowable decentering amount of the optical disc 8. In the embodiment, a suitable predetermined amount is of the order of 150 μm.

A lens position detection signal LSP signal is generated as an output of a summation amplifier 26 (used for adding the MPP signal and a signal obtained by multiplying the SPP signal to K2 by an amplifier 30) by the following formula:
LSP=MPP+K2×SPP
Here, K2 is set so that a push-pull signal modulation component does not remain in the LSP signal.

When a wavelength λ in the optical head is approximately equal to 660 nm, a numerical aperture NA of the objective lens is equal to 0.6, the optical disc has a groove pitch equal to 108 μm and a groove depth approximately equal to 60 nm, the groove width/land width in the optical disc is approximately equal to 1, the subbeam diameter is approximately 80 μm, and the subbeam displacement from a division line is equal to 8 μm, K2≅1.1×K1. This result is obtained on the basis of a simulation of setting K2 so that a push-pull signal modulation component does not remain in the LSP signal when K1 is set so that offset does not occur in the DPP signal when moving the objective lens 7 by the predetermined amount in a radial direction of the optical disc.

Adjusting the gain of each amplifier in this way makes it possible to prevent offset from occurring in the DPP signal even if the objective lens 7 is moved by approximately 150 μm in a radial direction of the optical disc. In addition, a proper tracking error signal and a proper lens position detection signal are generated so that a push-pull signal modulation component does not remain in the LPS signal.

While the present invention has been described with reference to what are presently considered to be the preferred embodiment, it is to be understood that the invention is not limited to the disclosed embodiment. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-018456 filed Jan. 27, 2004, which is hereby incorporated by reference herein.

1. An optical information recording/reproducing device comprising:
an optical element for dividing light emitted from a light source into a main beam and first and second subbeams by a wavefront splitter disposed between the light source and an objective lens;
a photodetector for receiving the main beam and the first and second subbeams after the main beam and the first and second subbeams are converged on a disc-shaped recording medium by the objective lens and are reflected by the disc-shaped recording medium; and
a circuit for generating a tracking control signal and an objective lens position detection signal on the basis of light signals received from the photodetector,
wherein the circuit amplifies a push-pull signal of the first and second subbeams at a first predetermined ratio and then determines a differential between the push-pull signal of the first and second subbeams and a push-pull signal of the main beam in order to generate the tracking control signal, and amplifies the push-pull signal of the first and second subbeams at a predetermined second ratio and then adds the push-pull signal of the first and second subbeams and the push-pull signal of the main beam in order to generate the objective lens position detection signal, the first predetermined ratio and the second predetermined ratio being different.

2. The optical information recording/reproducing device according to claim 1, wherein the optical element is a diffraction grating.

3. The optical information recording/reproducing device according to claim 1, wherein the first predetermined ratio is set so that offset does not occur in the tracking control signal when the objective lens is moved by a predetermined amount in a radial direction of the recording medium.

4. The optical information recording/reproducing device according to claim 1, wherein the second predetermined ratio is set so that a push-pull signal modulation component does not remain in the lens position detection signal.
